(19) United States
(12) Patent Application Publication
(10) Pub. No.: US 2025/0058512 A1
(43) Pub. Date: Feb. 20, 2025

(54) METHOD FOR PRODUCING A BENT THERMOPLASTIC COMPOSITE, A BENT THERMOPLASTIC COMPOSITE AND A SYSTEM FOR MANUFACTURING A BENT THERMOPLASTIC COMPOSITE

(71) Applicant: ARKEMA FRANCE, Colombes (FR)

(72) Inventors: Alexander ZOLLER, Lacq (FR); Pierre GERARD, Lacq (FR); Audrey LE FICHANT, Saint-Avold Cedex (FR)

(73) Assignee: ARKEMA FRANCE, Colombes (FR)

(21) Appl. No.: 18/720,947

(22) PCT Filed: Dec. 23, 2022
(86) PCT No.: PCT/EP2022/087819

§ 371 Date: Jun. 17, 2024

(30) Foreign Application Priority Data
Dec. 31, 2021 (FR) FR2114737

(51) Int. Cl. B29C 53/02; B29C 35/08; B29C 53/00; B29C 53/14; B29C 53/84; B29C 70/52; B29K 33/00; B29K 309/08

(52) U.S. Cl. CPC B29C 53/02; B29C 35/0805; B29C 53/005; B29C 53/14; B29C 53/84; B29C 70/52; B29C 2035/0811; B29K 2033/00; B29K 2309/08; B29K 2995/0012; B29K 2995/0077; B29K 2995/0082

(57) ABSTRACT

The invention relates to a method for producing a bent thermoplastic composite, comprising 35% or less in volume of a polymeric matrix including (meth)acrylic polymers, and at least 65% in volume of fiber, where the method includes (a) a step of providing the thermoplastic composite; (b) a step of heating a portion of the thermoplastic composite, said heating being selected between, conduction, radial and/or volumetric and the heating duration and/or the heating temperature being selected according to at least the thickness of the thermoplastic composite; (c) a step of creating a bent section in the heated portion by bending the heated portion; and (d) a step of cooling the bent section to solidify it and to form a bent thermoplastic composite, at a cooling temperature and/or a cooling duration selected in accordance with the glass transition temperatures (Tg) of the bent thermoplastic composite.

### FIELD OF THE INVENTION

The present invention relates to the field of thermoplastic composite and more preferably the field of reinforcing element.

The present invention concerns a method for producing a bent thermoplastic composite, a bent thermoplastic composite and a system for manufacturing a bent thermoplastic composite.

### DESCRIPTION OF RELATED ART

Reinforcing elements are commonly used to reinforce structures in several fields such as automotive, transport, aeronautic, aerospace, photovoltaic, construction and building, and/or wind energy applications.

Currently, it is known reinforcing element in the form of composite reinforcing elements.

Usually, a composite reinforcing element comprises a matrix (generally a polymeric matrix with thermosetting polymer) and fibers. Such composite reinforcing element are often produced by a pultrusion process and have a linear profile.

Conventional pultrusion processes involve wetting the fibers and impregnating them by passing them through a resin bath and cooling the impregnated bundle. This is then in a linear configuration. The resulting composite reinforcing elements are generally made directly in their final form (linear).

The linear form does not allow to meet all the requirements of industry. The thermosetting polymers cannot be applied universally due to the high transport volume and storage and are furthermore more expansive. In addition, with the evolution of the fields of application, new geometric shapes are necessary in particular bent reinforcing element.

It is known to manufacture reinforcing element with resin including thermoplastic polymer. Advantageously, the reinforcing element with thermoplastic polymer may be successively heated and cooled.

However, successive heating reduces the thermal stability and unfavorably some characteristics of the reinforcing element decrease such as bending resistance, flexural strength, retention and delamination.

Furthermore, as explained, thermosets cannot be changed in shape after cooling, so it is not possible to adapt the curvature to the structure to be reinforced or to modify them after cooling for transport or storage for example.

In addition, with current thermosetting or thermoplastic composite the point of curvature includes compression of the fibers which become unable to withstand tension and drastically reduces the reinforcement of the structures.

Moreover, nowadays thermoset need to be shaped manually within the pultrusion process which requires additional costs and time.

Currently, with the thermoplastic polymer, the heating is usually carried out in a conventional oven, and the thermoplastic polymer may be shaped several times. This facilitates the shaping on site and the problems of transport and storage.

However, the heating temperature and the duration of the heating with the current pultrusion process of thermoplastic polymer induces a degradation of surfaces, a possible degradation of the resin, and as the heating is not uniform, a significant thermal phase shift reducing thermal qualities between the center of the reinforcing element and its walls (for example outermost region). In addition, the heating is very slow (more than 5 minutes) and consequently slows down the manufacture and the production.

Hence, there is a need for a solution to produce bent thermoplastic composite with improved mechanical and chemical qualities particularly without degradation on the surface and with a reduced thermal phase shift while ensuring easier storage, transport time and cost.

### SUMMARY OF THE INVENTION

The following sets forth a simplified summary of selected aspects, embodiments and examples of the present invention for the purpose of providing a basic understanding of the invention. However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a method for producing a bent thermoplastic composite, from thermoplastic composite, said thermoplastic composite comprising 35% or less in volume of a polymeric matrix including (meth)acrylic polymers, and at least 65% in volume of fiber, said method comprising:
a step of providing the thermoplastic composite, preferably from a pultrusion process,
a step of heating a portion of the thermoplastic composite, said heating being selected between conduction, radial and/or volumetric and a heating duration and/or a heating temperature being selected according to at least a thickness of the thermoplastic composite,
a step of creating a bent section in the heated portion by bending the heated portion, and
a step of cooling the bent section to solidify it and to form a bent thermoplastic composite, at a cooling temperature and/or a cooling duration selected in accordance with the glass transition temperature (Tg) of the bent thermoplastic composite.

Such method allows to produce a bent thermoplastic composite with improved, mechanical and chemical qualities particularly without degradation on the surface and with a reduced thermal phase shift (delta) while ensuring saving time and reducing cost.

Indeed, thanks to the method the heating is rapid and depends on the thickness of the thermoplastic composite making it possible to adapt the heating to the thermoplastic composite and therefore to reduce the difference between the inside temperature and the surface temperature of the thermoplastic composite. This ensures that the phase shift responsible for the withstand is reduced even in the point of curvature.

In addition, the composition of the thermoplastic composite with 35% or less in volume of a polymeric matrix including (meth)acrylic polymers, and at least 65% in volume of fiber allow to reduce the heating temperature and the duration of the heating. Moreover, at least 65% in volume of fibers improved the mechanical and chemical properties of the bent section.

The method makes it possible to adapt the qualities of bending, resistance, and heat to thermoplastic composites, for a reinforcing element.

In addition, the method allows to facilitate storage and transport of a bent reinforcing element since the shaping may be made on site and conduct rapidly. The method also allows to adapt the curvature to the structure to be reinforced or to modify them after cooling.

According to Other Optional Features of the Method, it can Optionally Include One or More of the Following Characteristics Alone or in Combination:
the step of heating is a radial heating, preferably an infrared (IR) heating,
the heating duration is less than or equal to 95 seconds, preferably less than or equal to 60 seconds, preferably with an inside temperature of the thermoplastic composite being less than or equal to 180° C.,
between the step of heating and the step of cooling, the difference of temperature between an inside temperature and an outside temperature of thermoplastic composite goes from 0° C. to 50° C., preferably after 30 seconds of heating,
the temperature difference between an inside temperature and an outside temperature of thermoplastic composite during the heating step is less than or equal to 80° C. preferably in less or equal to 95 seconds of heating,
the thermoplastic composite is obtained from a pultrusion process, preferably a reactive pultrusion process,
the thermoplastic composite is crosslinked or partially crosslinked or not.

According to another aspect of the present invention, it is provided a bent thermoplastic composite obtained from a thermoplastic composite said thermoplastic composite including 35% or less in volume of a polymeric matrix including (meth)acrylic polymers, and at least 65% in volume of fiber.

Such bent thermoplastic composite presents an improved mechanical resistance even at the level of its curvature. The flexibility is improved, and the fibers of the bent thermoplastic composite have no buckling or cracks and present a homogeneous strength. In addition, such bent thermoplastic composite does not have degradation of its surface. Moreover, such bent thermoplastic composite can be easily bending, and on demand, close to the site. Advantageously a bent thermoplastic composite meets the requirement of the ASTM D7957 and more advantageously the requirement of the ASTM D7914, and presents similar bending properties to commercial thermoset hand-bent or more precisely bent before curing of the thermoset.

According to another aspect, the invention concerns a use of a bent thermoplastic composite according to the invention in automotive, transport, nautical, railroad, sport, aeronautic, aerospace, photovoltaic, construction and building, and/or wind energy applications. Preferably in order to reinforce a structure in automotive, transport, nautical, railroad, sport, aeronautic, aerospace, photovoltaic, construction and building, and/or wind energy applications.

Such use allows to reinforce structures in different fields of application.

According to another aspect, the invention relates to a system for manufacturing a bent thermoplastic composite from thermoplastic composite, said thermoplastic composite comprising 35% or less in volume of a polymeric matrix including (meth)acrylic polymers, and at least 65% in volume of fiber, said system comprising:
a heating device which is configured to heat a portion of the thermoplastic composite, said heating device being selected between, conduction, radial and/or volumetric and the heating duration and/or the heating temperature being selected according to at least the thickness of the thermoplastic composite,
a bending device which is configured to create a bent section in the heated portion by bending the heated portion, and
a cooling device which is configured to solidify the bent section and to form a bent thermoplastic composite, at a cooling temperature and/or a cooling duration selected in accordance with the glass transition temperature of the thermoplastic composite.

Such system allows to easily manufacture a bent thermoplastic composite. In addition, it allows to reduce time and cost.

### BRIEF DESCRIPTION OF DRAWINGS

The foregoing and other objects, features and advantages of the present invention will become more apparent from the following detailed description when taken in conjunction with the accompanying drawings in which:

FIG. 1 represents a flowchart of a method according to an embodiment of the invention.

FIG. 2 represents an example of the heating temperature and delta temperature according to the time for a thermoplastic composite rod D16 mm.

FIG. 3 represents an example of the heating temperature and delta temperature according to the time for a thermoplastic composite flat panel P4 mm.

FIG. 4 represents a schematic view of a system according to an embodiment of the invention.

### DETAILED DESCRIPTION

A description of example embodiments of the invention follows.

By “polymer” is meant either a copolymer or a homopolymer. The term “copolymer” means a polymer grouping together several different monomer units and the term “homopolymer” means a polymer grouping identical monomer units. By “block copolymer” is meant a polymer comprising one or more uninterrupted blocks of each of the distinct polymer species, the polymer blocks being chemically different from each other and being linked together by a covalent bond. These polymer blocks are also called polymer blocks.

The expression “polymer composite”, within the meaning of the invention, denotes a multicomponent material comprising at least two immiscible components in which at least one component is a polymer, and the other component may for example be a fibrous reinforcement.

By “fibrous reinforcement” or “fibrous substrate” or “fibers” is meant, within the meaning of the invention, several fibers, unidirectional fibers or of braids, or a continuous filament mat, fabrics, felts, or nonwovens which may be under the form of bands, webs, braids, wicks or pieces.

The term “matrix” is understood to mean a material serving as a binder and capable of transferring forces to the fibrous reinforcement. The “polymer matrix” includes polymers but can also include other compounds or materials. Thus, the “(meth) acrylic polymer matrix” refers to all types of compounds, polymers, oligomers, copolymers or block copolymers, acrylics and methacrylics. However, it would not be departing from the scope of the invention if the (meth) acrylic polymer matrix comprises up to 10% by weight, preferably less than 5% by weight of other non-acrylic monomers, chosen for example from the group: butadiene, isoprene, styrene, substituted styrene such as α-methylstyrene or tert-butylstyrene, cyclosiloxanes, vinylnaphthalenes and vinyl pyridines.

The term “initiator”, within the meaning of the invention, denotes a compound which can start/initiate the polymerization of a monomer or of monomers.

The term “polymerization” within the meaning of the invention refers to the process of converting a monomer or a mixture of monomers into a polymer.

The term “monomer”, within the meaning of the invention, denotes a molecule which can undergo polymerization.

For the purposes of the invention, the term “thermoplastic polymer” is understood to mean a polymer which is generally solid at room temperature, which may be crystalline, semi-crystalline or amorphous, and which softens during an increase in temperature, in particular after passing its glass transition temperature (Tg) and flowing at a higher temperature and being able to observe a clear melting at the passage of its so-called melting temperature (Tf) (when it is semi-crystalline), and which becomes solid again when the temperature drops below its melting point and below its glass transition temperature. This also applies for thermoplastic polymers slightly crosslinked by the presence of multifunctional monomers or oligomers in the formulation of the “syrup” (meth) acrylate, in percentage by mass preferably less than 10%, preferably less than 5% and so preferred less than 2% which can be thermoformed when heated above the softening temperature.

The term “thermosetting polymer” is understood to mean, within the meaning of the invention, a plastic material which irreversibly transforms by polymerization into an insoluble polymer network.

The term “(meth) acrylic monomer” is understood to mean any type of acrylic and methacrylic monomer.

The term “(meth) acrylic polymer” is understood to mean a polymer essentially comprising (meth) acrylic monomers which represent at least 50% by weight or more of the (meth) acrylic polymer.

The term “PMMA”, within the meaning of the invention, denotes homopolymers and copolymers of methyl methacrylate (MMA), the weight ratio of MMA in the PMMA preferably being at least 70% by weight for the MMA copolymer.

The expression “reinforcing element” as used is denoted an element used to support a structure in order to strengthen it, support it, solidify it, consolidate it, improve its mechanical properties (reinforcement, tension, stretching, etc.) its thermal, electrical and/or chemical properties

The term “rebar” as used is denoted a reinforcing bar that is used as a tension device in reinforced concrete and reinforced masonry structures to strengthen and aid the concrete under tension. Rebar significantly increases the tensile strength of concrete or the structure.

The abbreviation “phr” denotes parts by weight per hundred parts of composition. For example, 1 phr of initiator in the composition means that 1 kg of initiator is added to 100 kg of composition.

The abbreviation “ppm” denotes parts by weight per million parts of composition. For example, 1000 ppm of a compound in the composition means that 0.1 kg of the compound is present in 100 kg of the composition.

The expressions “inside temperature” or “core temperature” are used interchangeably and denote the core temperature of the thermoplastic composite as opposed to the “outside temperature” or “surface temperature” also used interchangeably and denote the temperature of the external surface of the thermoplastic composite. In addition, the temperature (inside or outside) may be measured and followed by thermocouple or infrared (IR) sensor.

As used herein, when a range is specified, the bounds are included.

The invention concerns a method 100 for producing a bent thermoplastic composite, from thermoplastic composite.

A bent thermoplastic composite come from a thermoplastic composite. Preferably the thermoplastic composite is obtained from a pultrusion process and more preferably from a reactive pultrusion process. The pultrusion and the reactive pultrusion process are known by the skilled in the art. In these processes, the fibers are guided through a resin bath or an injection chamber comprising the composition or the syrup. The fibers as fibrous substrate are for example in a form of a unidirectional roving or a continuous filament mat. After impregnation in the resin bath the wetted fibers are pulled through a heated device, where polymerization can take place.

However, pultrusion and reactive pultrusion expose the thermoplastic composite especially with fibrous reinforcements to thermal instability. Indeed, the thermoplastic is heated to high temperature (i.e. more than 150° C.) several times, and during a heating time more than 120 seconds. When thermoplastic composite is thermoformed or exposed longer time at higher temperature, some important characteristics change in an unfavorable manner as the decrease of the flexural strength, retention, delamination at the polymer and fiber interface and, additionally, degradation of the surface of the thermoplastic composite occur, the heating being not uniform (inside/outside the thermoplastic composite) and very slow. Indeed, a thermoplastic composite may comprise a first area (outside) and a second area (inside). The first and the second area may be different each other. Preferably the first area comprises the outside of the thermoplastic composite comprising its walls, its external surface and outermost regions, according to a first distance depending on the thermoplastic composite geometry. The second area comprises the inside of the thermoplastic comprising its core, its internal surface according to a second distance depending on the thermoplastic geometry. Preferably the first distance starts at the outermost region until the internal surface (excluded), and the second distance starts at the internal surface until the core of the thermoplastic. The first and the second distances may be equal or not.

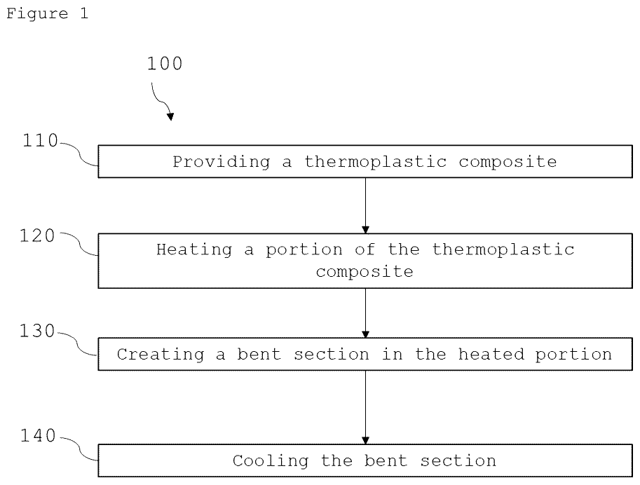

The invention proposes a new method with a new thermoplastic composite composition to overcome the disadvantages. An example of the method according to the invention is illustrated in FIG. 1. Advantageously the method 100 comprises a step of providing 110 the thermoplastic composite, a step of heating 120 a portion of the thermoplastic composite, a step of creating 130 a bent section in the heated portion, a step of cooling 140 the bent section.

The method according to invention comprise a step of providing 110 the thermoplastic composite. The thermoplastic composite comprises 35% or less in volume of a polymeric matrix including (meth)acrylic polymers, and at least 65% in volume of fiber. Such thermoplastic composite has a high thermal resistance and changes of mechanical and chemical properties are drastically reduced. The thermoplastic composite comprises at least 5% or more in volume of a polymeric matrix including (meth)acrylic polymers, and 95% or less in volume of fiber.

According to an embodiment, the thermoplastic composite may comprise from 20 to 30% in volume of a polymeric matrix and from 70 to 80% in volume of fiber.

According to another embodiment, the thermoplastic composite may comprise from 25 to 35% in volume of a polymeric matrix and from 65 to 75% in volume of fiber.

As regards of the fibers, mention may be made of several fibers, unidirectional rovings or continuous filament mat, fabrics, felts or nonwovens that may be in the form of strips, laps, braids, locks or pieces. The fibrous material of the composite may have various forms and dimensions, either one-dimensional, two-dimensional or three-dimensional. A fibrous material may comprise an assembly of one or more fibers. The origins of the fibrous material may be natural or synthetic. The fibers of the fibrous substrate may have a diameter between 0.005 μm and 100 μm, preferably between 1 μm and 50 μm, more preferably between 5 μm and 30 μm and advantageously between 10 μm and 25 μm.

The polymeric matrix includes (meth)acrylic polymers, preferably the weight-average molecular mass of the (meth) acrylic polymer (PI) should be high, which means greater than 50,000 g/mol and preferably greater than 100 000 g/mol.

The weight-average molecular mass can be measured by size exclusion chromatography (SEC).

As regards the (meth) acrylic monomer (M1), the monomer is chosen from alkyl acrylic monomers, alkyl methacrylic monomers, hydroxyalkyl acrylic monomers and hydroxyalkyl methacrylic monomers, and mixtures thereof.

According to an embodiment, at least 50% by weight and preferably at least 60% by weight of the (meth) acrylic monomer (M1) is methyl methacrylate.

According to another embodiment, at least 50% by weight, preferably at least 60% by weight, more preferably at least 70% by weight, advantageously at least 80% by weight and even more advantageously 90% by weight of the monomer (M1) is a mixture of methyl methacrylate with optionally at least one other monomer. Preferably the at least one other monomer is a (meth) acrylic monomer (M2) chosen from a compound comprising at least two (meth) acrylic functions. The (meth) acrylic monomer (M2) can be present in (meth) acrylic composition MCI between 0.01 and 10 phr by weight.

Advantageously the (meth) acrylic polymer (PI) is fully soluble in the (meth) acrylic monomer (M1) or in the mixture of (meth) acrylic monomers.

According to an embodiment the thermoplastic composite may be crosslinked or partially crosslinked or not. Preferably the thermoplastic composite remains thermoformable.

The polymerization may take place at a temperature typically below 140° C., preferably below 130° C. and even more preferably below 125° C.

Preferably the polymerization may take place at temperature between 40° C. and 140° C., preferably between 50° C. and 130° C., even more preferably between 60° C. and 125° C.

The thermoplastic composite according to the invention stands out to excellent mechanic characteristics: For example: Tensile strength: more than 1,000 MPa.

TABLE 1
Mechanic characteristics from a thermoplastic
composite according to the invention with glass fiber

| Thermoplastic composite | Strength | | Modulus |
|---|---|---|---|
| with glass fiber | (MPa) | | (GPa) |
| Flexural 0° | 1265 ± 38 | | 50.4 ± 0.9 |
| Flexural 90° | 68.9 ± 2.7 | | 11.5 ± 0.3 |
| Tensile 0° | 1207 ± 54 | | 58 ± 1.1 |
| Compression 0° | 1181 ± 133 | | 54.9 ± 1.0 |
| ILSS | 58.6 ± 1.2 | | |
| Glass transition (Tg) | 119° | C. | |
| Residual monomer (8) | 0.2 ± 0.01% | | |
| Fiber fraction (vol %) | 69 | vol % | |

| | |
|---|---|
| Porosity (%) | 0.42% |

The invention comprises a step of heating 120 a portion of the thermoplastic composite.

Preferably, a portion corresponds to a part of the whole thermoplastic composite which is heated. According to an embodiment, several portions may be heated, at the same time or several portions may be heated at different times, for example as the composite thermoplastic advances.

The heating allows to soften the said portion of the thermoplastic composite in order to facilitate the next step of creating a bent. As explained thermoplastic composite have the specificity of being generally solid at room temperature and which softens during an increase in temperature, in particular after passing its glass transition temperature (Tg) and which becomes solid again when the temperature drops below its melting point and/or below its glass transition temperature. The step of heating allows to improve the heating speed which is faster and to improve the heating homogenization.

The heating may be selected between conduction, radial and/or volumetric.

According to a first aspect, the heating step is carried out by a conduction heating.

A conduction heating may take place between the thermoplastic composite and a metal by direct contact between them. Metals are very good conductors of heat and preferably the metal may be a mold, a closed mold.

The conduction heating allows to reach a range of temperature inside or outside the thermoplastic composite rather than a target temperature.

According to an embodiment, the range of temperature may be between 160° C. and 230° C. for the outside temperature and between 80° C. to 160° C. for the inside temperature of the thermoplastic composite, preferably with a heating source about 250° C. Preferably, these ranges are reached between 10 and 25 seconds for the outside temperature and between 25 and 50 seconds for the inside temperature. In an example of this embodiment, the thermoplastic composite may be a thermoplastic composite rod, more preferably for a D13 rod having a diameter of 13 mm.

According to another embodiment, the range of temperature may be between 140° C. and 180° C. for the outside temperature and between 80° C. to 120° C. for the inside temperature of the thermoplastic composite, preferably with a heating source about 200° C. Preferably, these ranges are reached between 10 and 25 seconds for the outside temperature and between 25 and 50 seconds for the inside temperature. In an example of this embodiment, the thermoplastic composite may be a thermoplastic composite rod, more preferably for a D13 rod having a diameter of 13 mm.

Advantageously, the duration of the heating is less than or equal to 60 seconds, preferably less than or equal to 50 seconds, more preferably less than or equal to 30 seconds, and/or more than 1 second, preferably more than or equal to 5 seconds, more preferably more than or equal to 10 seconds, preferably with a heating source between 200° C. and 250° C. for an external diameter of the thermoplastic composite of less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm

Advantageously, the core temperature may be between 80° C. and 160° C. preferably between 80° C. and 120° C., reached in less than or equal to 60 seconds, preferably less than or equal to 55 seconds, more preferably less than or equal to 50 seconds, and/or more than or equal to 5 seconds, more preferably more than or equal to 10 seconds with a heating source between 200° C. et 250° C. Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the outside temperature may be between 140° C. and 230° C. preferably between 140° C. and 180° C., reached in less than or equal to 35 seconds, preferably less than or equal to 30 seconds, more preferably less than or equal to 25 seconds, and/or more than 1 second, more preferably more than or equal to 5 seconds, preferably with a heating source between 200° C. and 250° C. Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Always in the first aspect with conductive heating, and according to another embodiment, the range of temperature may be between 16° and 240° C. for the outside temperature and between 140 to 240° C. for the inside temperature of the thermoplastic composite, preferably with a heating source about 240° C. Preferably, these ranges are reached between 10 and 30 seconds. In an example of this embodiment, the thermoplastic composite may be a thermoplastic composite panel, more preferably for a P2 having a thickness of 2 mm.

According to another embodiment, the range of temperature may be between 15° and 180° C. for the outside temperature and between 100 to 180° C. for the inside temperature of the thermoplastic composite, preferably with a heating source about 180° C. Preferably, these ranges are reached between 10 and 30 seconds. In an example of this embodiment, the thermoplastic composite may be a thermoplastic composite pane more preferably for a P2 having a thickness of 2 mm.

Advantageously, the duration of the heating is less than or equal to 95 seconds, preferably less than or equal to 90 seconds, more preferably less than or equal to 70 seconds, and even more preferably less than or equal to 60 seconds, and/or more than 1 second, preferably more than or equal to 5 seconds, more preferably more than or equal to 10 seconds, preferably with a heating source between 180° C. and 240° C. Preferably, these values correspond to a thermoplastic composite having a thickness less than or equal to 30 mm, preferably less than or equal to 20 mm, more preferably less than or equal to 10 mm, and even more preferably less than or equal to 5 mm and/or more than or equal to 1 mm more preferably more than or equal to 1.5 mm, and/or for a thickness of the thermoplastic between 1 mm and 30 mm, preferably between 1.5 mm and 20 mm, more preferably between 2 mm and 16 mm.

Advantageously, the core temperature may be between 100° C. and 240° C., preferably between 140° C. and 180° C., reached in less than or equal to 45 seconds, preferably less than or equal to 40 seconds, more preferably less than or equal to 35 seconds, and even more preferably less than or equal to 30 seconds, and/or more than or equal to 2 seconds, more preferably more than or equal to 5 seconds, preferably with a heating source between 180° C. et 240° C. Preferably, these values correspond to a thermoplastic composite having a thickness less than or equal to 30 mm, preferably less than or equal to 20 mm, and more preferably less than or equal to 10 mm, and even more preferably less than or equal to 5 mm and/or more than or equal to 1 mm more preferably more than or equal to 1, 5 mm, and/or for a thickness of the thermoplastic between 1 mm and 30 mm, preferably between 1.5 mm and 20 mm, more preferably between 2 mm and 16 mm.

Advantageously, the outside temperature may be between 150° C. and 240° C., preferably between 160° C. and 180° C., reached in less than or equal to 45 seconds, preferably less than or equal to 40 seconds, more preferably less than or equal to 35 seconds, and even more preferably less than or equal to 30 seconds, and/or more than or equal to 2 seconds, more preferably more than or equal to 5 seconds, preferably with a heating source between 180° C. et 240° C. Preferably, these values correspond to a thermoplastic composite having a thickness less than or equal to 30 mm, preferably less than or equal to 20 mm and more preferably less than or equal to 10 mm and even more preferably less than or equal to 5 mm and/or more than or equal to 1 mm more preferably more than or equal to 1, 5 mm, and/or for a thickness of the thermoplastic between 1 mm and 30 mm, preferably between 1.5 mm and 20 mm, more preferably between 2 mm and 16 mm.

A conduction heating is faster than a convection heating (i.e.: 15 minutes of heating for an inside temperature at 180° C. with a heating source at 200° C. by convection heating). Indeed, typically with a convection heating, the heating duration is really slow more than 10 minutes, and the heating is heterogeneous, i.e. until the core temperature is reached to be able to bend the composite thermoplastic, the surface of the thermoplastic is degraded (reducing chemical and mechanical properties), or, if the outer surface is not degraded, the core temperature is not sufficient to subsequently be able to bend the composite thermoplastic.

The heating duration and/or the heating temperature may be selected according to at least the thickness of the thermoplastic composite, and/or according to the diameter (external or internal) and/or according to a target core temperature or an external (surface) target temperature and/or a desired heating time. The heating temperature and/or the heating duration may depend on the temperature of the heating source and/or the metal of the mold for example.

Preferably, the temperature difference between the inside temperature and the outside temperature during the heating step may be less than or equal to 95° C., preferably less than or equal to 80° C., more preferably less than or equal to 70° C. and even more preferably less than or equal to 60° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating. Preferably the difference between the inside temperature and the outside temperature during the heating step may be more than or equal to 0° C., preferably more than or equal to 1° C., more preferably more than or equal to 2° C., and even more preferably more than or equal to 5° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating.

Advantageously, the inside temperature may be between 160° C. and 180° C.

According to a second aspect, the heating may be a radial heating.

A radial heating may be by Infra-red (IR) comprising preferably Near Infra-Red and Mid-Infra-red. The IR is faster than convection and conduction. Preferably, the step of heating is a radial heating and more preferably an IR heating. Indeed, near infrared (NIR) or mid infrared (MIR) are more preferred for heating, with a heating source preferably from 20 to 70 kW/m², preferably 45 to 65 kW/m² for NIR and, from 30 to 60 kW/m², more preferably from 45 to 55 kW/m² for MIR.

An IR heating allows to reduce the heating time of less than or equal to 100 seconds, preferably less than or equal to 90 seconds, more preferably less than or equal to 60 seconds and even more preferably less than or equal to 30 seconds. This makes it possible to obtain, in one embodiment of the invention, a core temperature of about 180° C. with an outside temperature of 200 to 250° C. In addition, the heating is homogeneous.

TABLE 2
Heating time (seconds)

| | Rod | Panel | Panel |
|---|---|---|---|
| | D16 mm | 2 mm | 4 mm |
| NIR 48 kW/m² | 77 s | 20 s | 30 s |
| NIR 65 kW/m² | 67 s | | 18 s |
| MIR 47 kW/m² | 95 s | 20 s | 28 s |

The table 2 discloses some values of the heating duration according to the composite (rod or panel for example) and according to the heating source (NIR or MIR) to obtain a core temperature of 180° C. with an outside temperature of 200° C. to 250° C. The IR heating is faster than a convection heating regardless of the geometry of the thermoplastic composite and homogeneous, allowing to reach a core temperature about of 180° C. and an outside temperature between 200° C. to 250° C.

According to an embodiment of the second aspect of the invention, the range of temperature may be between 80° C. and 240° C. for the outside temperature and between 140° C. to 200° C. for the inside temperature of the thermoplastic composite, preferably with a heating source of about Q=3.5·10⁷ W·m⁻³. Preferably, these ranges are reached between 10 and 25 seconds for the outside temperature and between 25 and 50 seconds for the inside temperature. In an example of this embodiment, the thermoplastic composite may be a thermoplastic composite rod, more preferably for a D13 rod having a diameter of 13 mm.

According to another embodiment, the range of temperature may be between 60° C. and 160° C. for the outside temperature and between 90° C. to 130° C. for the inside temperature of the thermoplastic composite, preferably with a heating source of about Q=2.10⁷ W·m⁻³. Preferably, these range are reached between 10 and 25 seconds for the outside temperature and between 25 and 50 seconds for the inside temperature. In an example of this embodiment, the thermoplastic composite may be a thermoplastic composite rod, more preferably for a D13 rod having a diameter of 13 mm.

Advantageously, the duration of the heating is less than or equal to 60 seconds, preferably less than or equal to 55 seconds, more preferably less than or equal to 50 seconds, and/or more than 1 second, preferably more than or equal to 5 seconds, preferably with a heating source between Q=3.5.10⁷ W·m⁻³ and Q=2.10⁷ W·m⁻³ preferably, for an external diameter of the thermoplastic composite less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the core temperature may be between 90° C. and 200° C., preferably between 100° C. and 140° C., reached in less than or equal to 60 seconds, preferably less than or equal to 55 seconds, more preferably less than or equal to 50 seconds, and/or more than 5 seconds, more preferably more than or equal to 10 seconds with a heating source between Q=3.5.10⁷ W·m⁻³ and Q=2.10⁷ W·m⁻³. Preferably, these values correspond to a thermoplastic composite having an external diameter less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the outside temperature may be between 60° C. and 240° C., preferably between 80° C. and 160° C., reached in less than or equal to 30 seconds, preferably less than or equal to 25 seconds, and/or more than 1 second, more preferably more than or equal to 5 seconds, preferably with a heating source between Q=3.5.10⁷ W·m⁻³ and Q=2.10⁷ W·m⁻³. Preferably, these values correspond to a thermoplastic composite having an external diameter less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

According to another embodiment of the second aspect, the range of temperature may be between 150° C. and 210° C. for the outside temperature and between 150° C. to 200° C. for the inside temperature of the thermoplastic composite, preferably with a IRM source of about 47 kW·m². Preferably, these ranges are reached between 25 and 50 seconds for the outside temperature and between 50 and 95 seconds for the inside temperature. In an example of this embodiment, the thermoplastic composite may be a thermoplastic composite rod, more preferably for a D16 rod having a diameter of 13 mm.

According to another embodiment, the range of temperature may be between 40° C. and 220° C. for the outside temperature and between 40° C. to 180° C. for the inside temperature of the thermoplastic composite, preferably with an IRC source about 50 kW·m². Preferably, these ranges are reached between 10 and 80 seconds for the outside temperature and between 10 and 80 seconds for the inside temperature. In an example of this embodiment, the thermoplastic composite may be a thermoplastic composite rod, more preferably for a D16 rod having a diameter of 13 mm.

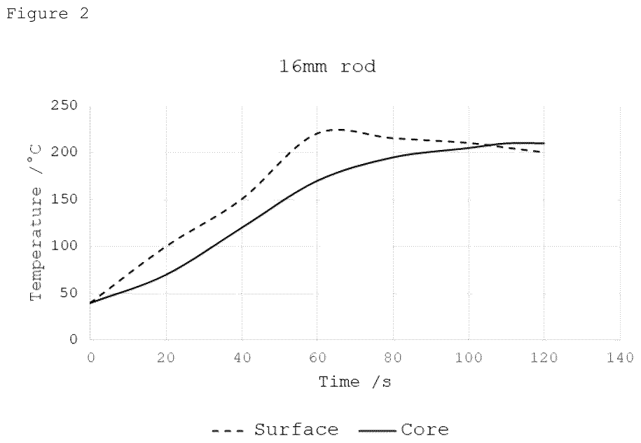

According to another embodiment illustrated in FIG. 2, the range of temperature may be between 40° C. and 200° C. for the outside temperature and between 40° C. to 190° C. for the inside temperature of the thermoplastic composite, preferably with an IR source between 50 kW·m² and 65 kW·m². Preferably, these ranges are reached between 1 and 80 seconds for the outside temperature and between 1 and 80 seconds for the inside temperature. In an example of this embodiment, the thermoplastic composite may be a thermoplastic composite rod, more preferably for a D16 rod having a diameter of 13 mm.

Some values are reported below in table 3 for a D16 rod having a diameter of 13 mm with an IR source.

TABLE 3
Heating times and surface and core temperature of
a D16 rod having a diameter of 13heated with near IR

| | | Surface | Core |
|---|---|---|---|
| | Times (s) | (° C.) | (° C.) |
| Near IR-D16 mm | 0 | 40 | 40 |
| | 20 | 100 | 70 |
| | 40 | 150 | 120 |
| | 60 | 220 | 170 |
| | 80 | 215 | 195 |
| | 100 | 210 | 205 |
| | 110 | 205 | 210 |
| | 120 | 200 | 210 |

Advantageously, the heating duration is less than or equal to 95 seconds, preferably less than 60 seconds with an inside temperature of the thermoplastic composite being less than or equal to 180° C. In addition, the difference of the temperature between the inside temperature and the outside temperature is less or equal to 80° C. preferably less than or equal to 70° C., more preferably less than or equal to 60° C. and even more preferably less than or equal to 50° C. and greater than or equal to 5° C., preferably more than or equal to 10° C. in less or equal to 95 seconds of heating, preferably in less than or equal to 90 seconds of heating, more preferably in less than or equal to 80 seconds and even more preferably in less than or equal to 60 seconds.

Advantageously, the duration of the heating is less than or equal to 95 seconds, preferably less than or equal to 80 seconds, more preferably less than or equal to 60 seconds, and/or more than 1 second, preferably more than or equal to 5 seconds, more preferably more than or equal to 10 seconds, preferably with a heating source between 47 kW·m² and 65 kW·m² for an external diameter of the thermoplastic composite of less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm

Advantageously, the outside temperature may be between 40° C. and 200° C. preferably between 80° C. and 180° C., reached in less than or equal to 95 seconds, preferably less than or equal to 80 seconds, more preferably less than or equal to 60 seconds, and/or more than or equal to 5 seconds, more preferably more than or equal to 10 seconds with a heating source between 47 kW·m² and 65 kW·m². Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the inside temperature may be between 40° C. and 200° C. preferably between 70° C. and 180° C., reached in less than or equal to 95 seconds, preferably less than or equal to 80 seconds, more preferably less than or equal to 60 seconds, and/or more than 1 second, more preferably more than or equal to 5 seconds, preferably with a heating source between 47 kW·m² and 65 kW·m². Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

According to another embodiment, the range of temperature may be between 8° and 240° C. for the outside temperature and between 80 to 240° C. for the inside temperature of the thermoplastic composite, preferably with a heating source about Q=2.5·10⁷ W·m⁻³. Preferably, these ranges are reached between 10 and 30 seconds. In an example of this embodiment, the thermoplastic composite may be a thermoplastic composite panel, more preferably for P2 panel having a thickness of 2 mm.

According to another embodiment, the range of temperature may be between 7° and 180° C. for the outside temperature and between 70 to 180° C. for the inside temperature of the thermoplastic composite, preferably with a heating source about Q=1.75·10⁷ W·m⁻³. Preferably, these ranges are reached between 10 and 30 seconds. In an example of this embodiment, the thermoplastic composite may be a thermoplastic composite panel, more preferably for P2 panel having a thickness of 2 mm.

According to another embodiment, the range of temperature may be between 100° C. and 220° C. for the outside temperature and between 70° C. to 180° C. for the inside temperature of the thermoplastic composite, preferably with a IRM source about 47 kW·m². Preferably, these ranges are reached between 10 and 40 seconds for the outside temperature and between 10 and 40 seconds for the inside temperature. In an example of this embodiment, the thermoplastic composite may be a thermoplastic composite panel, more preferably a P4 panel having a thickness of 4 mm.

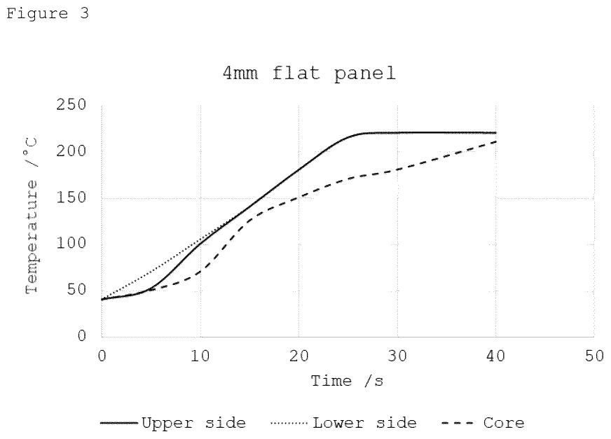

According to another embodiment illustrated in the FIG. 3, the range of temperature may be between 110° C. and 220° C. for the outside temperature and between 70° C. to 210° C. for the inside temperature of the thermoplastic composite, preferably with an IRC source about 50 kW·m² to 65 kW·m². Preferably, these ranges are reached between 10 and 30 seconds for the outside temperature and between 10 and 40 seconds for the inside temperature. In an example of this embodiment, the thermoplastic composite may be a thermoplastic composite panel, more preferably for a P4 panel having a thickness of 4 mm.

Some values are reported below for a P4 panel having a thickness of 4 mm with an IR source.

TABLE 4
Heating times and upper and lower surface and core
temperature of a P4 panel heated with near IR

| | | Surface- | Surface- | |
|---|---|---|---|---|
| | Times | Upper | Lower | Core |
| | (s) | (° C.) | (° C.) | (° C.) |
| Near IR-P4 | 0 | 40 | 40 | 40 |
| 4 mm | 5 | 52 | 70 | 50 |
| | 10 | 100 | 105 | 70 |
| | 15 | 140 | 140 | 125 |
| | 20 | 180 | 180 | 150 |
| | 25 | 215 | 215 | 170 |
| | 30 | 220 | 220 | 180 |
| | 40 | 220 | 220 | 210 |

Advantageously, the duration of the heating is less than or equal to 40 seconds, preferably less than or equal to 35 seconds, more preferably less than or equal to 30 seconds and/or more than 1 second, preferably more than or equal to 5 seconds with a heating source between Q=1.75·10⁷ W·m⁻³ and Q=2.5·10⁷ W·m⁻³ or between 47 kW·m² and 65 kW·m², preferably, for a thickness of the thermoplastic composite less than or equal to 30 mm, preferably less than or equal to 20 mm, more preferably less than or equal to 10 mm and even more preferably less than or equal to 5 mm and/or more than or equal to 1 mm more preferably more than or equal to 1.5 mm, and/or for a thickness of the thermoplastic between 1 mm and 30 mm, preferably between 1.5 mm and 20 mm, more preferably between 2 mm and 16 mm.

Advantageously, the core temperature and the outside temperature may be between 70° C. and 240° C. preferably between 80° C. and 220° C., more preferably between 90° C. and 180° C. reached in less than or equal to 40 seconds, preferably less than or equal to 30 seconds, more preferably less than or equal to 25 seconds even more preferably less than or equal to 20 seconds and/or more than 1 second more preferably more than or equal to 5 seconds with a heating source between Q=1.75·10⁷ W·m⁻³ and Q=2.5·10⁷ W·m⁻³ or between 47 kW·m² and 65 kW·m². Preferably, these values correspond to a thermoplastic composite having thickness less than or equal to 30 mm, preferably less than or equal to 20 mm and more preferably less than or equal to 10 mm even more preferably less than or equal to 5 mm and/or more than or equal to 1 mm more preferably more than or equal to 1.5 mm, and/or for a thickness of the thermoplastic between 1 mm and 30 mm, preferably between 1.5 mm and 20 mm, more preferably between 2 mm and 16 mm.

The radial heating allows to improve the duration of heating (i.e. reduce), and to ensure sufficiently uniform heating of the portion to the central zone in relatively short times, without the temperature of the outer surface rising so much that the material degrades.

The heating duration and/or the heating temperature may be selected according to at least the thickness of the thermoplastic composite, and/or according to the diameter (internal or external) and/or according to a target core temperature and/or an external (surface) target temperature and/or a desired heating time. The heating temperature and/or the heating duration may depend on wavelength ranges of the irradiation and/or irradiation power.

It may be noted that with IR heating, the source may be either by surface power (the power of IR lamps for example) or by a volume heat source. Those skilled in the art know the difference and what type of surface or volume source to use.

Preferably, the temperature difference between the inside temperature and the outside temperature during the heating step may be less than or equal to 95° C., preferably less than or equal to 80° C., more preferably less than or equal to 70° C. and even more preferably less than or equal to 60° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating. Preferably the difference between the inside temperature and the outside temperature during the heating step may be more than or equal to 0° C., preferably more than or equal to 1° C., more preferably more than or equal to 2° C., and even more preferably more than or equal to 5° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating.

According to another aspect of the present invention, the heating step may comprise a volumetric heating.

A volumetric heating may comprise microwave. The microwave power may be more than or equal to 1 KW, preferably more than or equal to 5 KW and more preferably more than or equal to 10 KW. Preferably the microwave power may be less than or equal to 30 KW, preferably less than or equal to 25 KW and more preferably less than or equal to 20 KW. The frequency may be more than or equal to 900 MHz, preferably more than or equal to 1 GHz, more preferably more than or equal to 1.5 GHZ and even more preferably more than or equal to 2 GHz. The frequency may be less than or equal to 8 GHz, preferably less than or equal to 7 GHz and more preferably less than or equal to 6 GHz. In a preferred embodiment, the frequency may be of 2.45 GHZ and the microwave power of 1 kW.

The heating duration and/or the heating temperature may be selected according to at least the thickness of the thermoplastic composite, or according to the external diameter or according to a target core temperature or an external (surface) target temperature or a desired heating time. The heating temperature and/or the heating duration may depend on the frequency and/or the microwave power.

According to an embodiment, the range of temperature may be between 140° C. and 230° C. for the outside temperature and between 140° C. to 230° C. for the inside temperature of the thermoplastic composite, preferably with a heating source about Q=2·10⁷ W·m⁻³. Preferably, these ranges are reached between 10 and 25 seconds for the outside temperature and between 10 and 25 seconds for the inside temperature. In an example of this embodiment, the thermoplastic composite may be a thermoplastic composite rod, more preferably for a D13 rod having a diameter of 13 mm.

According to another embodiment, the range of temperature may be between 100° C. and 180° C. for the outside temperature and between 100° C. to 180° C. for the inside temperature of the thermoplastic composite, preferably with a heating source about Q=1.3·10⁷ W·m⁻³. Preferably, these ranges are reached between 10 and 25 seconds for the outside temperature and between 10 and 25 seconds for the inside temperature. In an example of this embodiment, the thermoplastic composite may be a thermoplastic composite rod, more preferably for a D13 rod having a diameter of 13 mm

According to another embodiment, the range of temperature may be between 120° C. and 230° C. for the outside temperature and between 120° C. to 230° C. for the inside temperature of the thermoplastic composite, preferably with a heating source about Q=2·10⁷ W·m⁻³. Preferably, these ranges are reached between 10 and 25 seconds for the outside temperature and between 10 and 25 seconds for the inside temperature. In an example of this embodiment, the thermoplastic composite may be a thermoplastic composite rod, more preferably for a D30 rod having a diameter of 30 mm

According to another embodiment, the range of temperature may be between 10° and 180° C. for the outside temperature and between 100 to 180° C. for the inside temperature of the thermoplastic composite, preferably with a heating source about Q=1.3·10⁷ W·m³. Preferably, these ranges are reached between 10 and 25 seconds. In an example of this embodiment, the thermoplastic composite may be a thermoplastic composite rod, more preferably for a D30 rod having a diameter of 30 mm

Advantageously, the duration of the heating is less than or equal to 30 seconds, preferably less than or equal to 25 seconds, more preferably less than or equal to 20 seconds and/or more than 1 second, preferably more than or equal to 5 seconds with a heating source between Q=1.0·10⁷ W·m⁻³ and Q=3·10⁷ W·m⁻³ preferably between Q=1.3·10⁷ W·m⁻³ and Q=2·10⁷ W·m⁻³ preferably for an external diameter of the thermoplastic composite of less than or equal to 30 mm, preferably less than or equal to 25 mm and more preferably less than or equal to 20 mm, and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the core temperature may be between 100° C. and 230° C. preferably between 120° C. and 180° C., reached in less than or equal to 30 seconds, preferably less than or equal to 25 seconds, more preferably less than or equal to 20 seconds and/or more than 1 second, more preferably more than or equal to 5 seconds, with a heating source between Q=1.0·10⁷ W·m⁻³ and Q=3·10⁷ W·m⁻³ preferably Q=1.3·10⁷ W·m⁻³ and Q=2·10⁷ W·m⁻³. Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

Advantageously, the outside temperature may be between 100° C. and 230° C. preferably between 120° C. and 180° C., reached in less than or equal to 25 seconds, preferably less than or equal to 20 seconds, more preferably less than or equal to 15 seconds and/or more than 1 second, more preferably more than or equal to 5 seconds with a heating source between Q=1.0·10⁷ W·m⁻³ and Q=3·10⁷ W·m⁻³ preferably Q=1.3·10⁷ W·m⁻³ and Q=2·10⁷ W·m⁻³. Preferably, these values correspond to a thermoplastic composite having an external diameter less than or equal to 30 mm, preferably less than or equal to 25 mm and more preferably less than or equal to 20 mm and/or for an external diameter of the thermoplastic composite more than or equal to 2 mm, preferably more than or equal to 4 mm, more preferably more than or equal to 6 mm, and/or for an external diameter of the thermoplastic composite between 2 mm and 30 mm, preferably between 4 mm and 25 mm, more preferably between 6 mm and 20 mm.

According to another embodiment of the aspect of the invention, the range of temperature may be between 10° and 220° C. for the outside temperature and between 100 to 220° C. for the inside temperature of the thermoplastic composite, preferably with a heating source about Q=1.9·10⁷ W·m⁻³. Preferably, these ranges are reached between 10 and 25 seconds. In an example of this embodiment, the thermoplastic composite may be a thermoplastic composite panel, more preferably for P2 panel having a thickness of 2 mm.

According to another embodiment, the range of temperature may be between 90° C. and 180° C. for the outside temperature and between 90° C. to 180° C. for the inside temperature of the thermoplastic composite, preferably with a heating source about Q=1.4·10⁷ W·m⁻³. Preferably, these ranges are reached between 10 and 25 seconds for the outside temperature and between 10 and 25 seconds for the inside temperature. In an example of this embodiment, the thermoplastic composite may be a thermoplastic composite panel, more preferably for P2 panel having a thickness of 2 mm.

According to another embodiment, the range of temperature may be between 10° and 220° C. for the outside temperature and between 100 to 220° C. for the inside temperature of the thermoplastic composite, preferably with a heating source about Q=1.9·10⁷ W·m⁻³. Preferably, these ranges are reached between 10 and 30 seconds. In an example of this embodiment, the thermoplastic composite may be a thermoplastic composite panel, more preferably for P4 panel having a thickness of 4 mm.

According to another embodiment, the range of temperature may be between 90° C. and 180° C. for the outside temperature and between 90° C. to 180° C. for the inside temperature of the thermoplastic composite, preferably with a heating source about Q=1.4·10⁷ W·m⁻³. Preferably, these ranges are reached between 10 and 30 seconds for the outside temperature and between 10 and 30 seconds for the inside temperature. In an example of this embodiment, the thermoplastic composite may be a thermoplastic composite panel, more preferably for P4 panel having a thickness of 4 mm.

Advantageously, the duration of the heating is less than or equal to 95 seconds, preferably less than or equal to 60 seconds, more preferably less than or equal to 30 seconds, and even more preferably less than or equal to 20 seconds and/or more than 1 second, preferably more than or equal to 5 seconds with a heating source between Q=1.0·10⁷ W·m⁻³ and Q=3.0·10⁷ W·m⁻³, preferably between Q=1.4·10⁷ W·m⁻³ and Q=1.9·10⁷ W·m⁻³, for a thickness of the thermoplastic composite less than or equal to 30 mm, preferably less than or equal to 20 mm, more preferably less than or equal to 10 mm, and even more preferably less than or equal to 5 mm and/or more than or equal to 1 mm more preferably more than or equal to 1.5 mm, and/or for a thickness of the thermoplastic between 1 mm and 30 mm, preferably between 1.5 mm and 20 mm, more preferably between 2 mm and 16 mm.

Advantageously, the core temperature and/or the outside temperature may be between 90° C. and 220° C. preferably between 100° C. and 180° C., reached in less than or equal to 30 seconds, preferably less than or equal to 25 seconds, more preferably less than or equal to 20 seconds, even more preferably less than or equal to 15 seconds, and/or more than 1 second, more preferably more than or equal to 5 seconds with a heating source between Q=1.0·10⁷ W·m⁻³ and Q=3.0·10⁷ W·m⁻³, preferably between Q=1.4·10⁷ W·m⁻³ and Q=1.9·10⁷ W·m⁻³. Preferably, these values correspond to a thermoplastic composite having thickness less than or equal to 30 mm, preferably less than or equal to 20 mm, more preferably less than or equal to 10 mm, and even more preferably less than or equal to 5 mm and/or more than or equal to 1 mm more preferably more than or equal to 1.5 mm, and/or for a thickness of the thermoplastic between 1 mm and 30 mm, preferably between 1.5 mm and 20 mm, more preferably between 2 mm and 16 mm.

Preferably, the temperature difference between the inside temperature and the outside temperature during the heating step may be less than or equal to 95° C., preferably less than or equal to 80° C., more preferably less than or equal to 70° C. and even more preferably less than or equal to 60° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating. Preferably the difference between the inside temperature and the outside temperature during the heating step may be more than or equal to 0° C., preferably more than or equal to 1° C., more preferably more than or equal to 2° C., and even more preferably more than or equal to 5° C. in less or equal to 95 seconds of heating, preferably in less than or equal to 80 seconds of heating and more preferably in less than or equal to 60 seconds of heating, and/or in more than 1 second of heating, preferably more than or equal to 10 second of heating.

According to another aspect of the invention the step of heating may comprise the establishment of formula with upper and lower limits for time and temperature to reach. The formula may comprise some variables such as function of diameter, and/or of heating source, and/or of dimension, and/or of thermoplastic composite composition, and/or thermoplastic composite geometry.

Advantageously, the heating duration is less than or equal to 95 seconds, preferably less than or equal to 60 seconds, preferably with an inside temperature of the thermoplastic composite being less than or equal to 180° C.

It may be noted that with volumetric heating, the source may be either by surface power or by a volume heat source. Those skilled in the art know the difference and what type of surface or volume source to use.

The method according to the invention comprises a step of creating 130 a bent section in the heated portion by bending the heated portion.

The heated portion may be shaped with different geometry thank to the heated thermoplastic composite. The step of creating a bent section allows to change the form of the thermoplastic composite.

The thermoplastic composite is preferably linear and the step of creating a bent allows to shape the heated portion. The creating bent section may be a bend, a curve, a complex shape, or a combination of any of the foregoing.

For a section having a bend, a bend may from an angle, for example, within a range of 5° to 180°, from 5° to 135°, or from 10° to 90°.

The step of creating a bent may be by simple bending, compression curving, folding and/or twisting. Preferably, the step of creating a bent includes twisting.

The simple bending comprises a compression at the inner fiber and tension at the outer fiber. The bending may be realized thank to fixture tools, weight on either side of the thermoplastic composite or with a mold.

The compression comprises preferably, a pre-stress tension in order to decrease the path length and to reduce possible cracks. Preferably the compression is before the bending. According to an embodiment, the compression leads to an oval form that can be bent more easily. The compression may comprise press and/or mold.

According to an embodiment, the step of creating a bent may comprise a pressure applied to the heated portion. The pressure may be comprised between 1 bar and 150 bars, preferably between 3 bars and 100 bars, more preferably between 5 bars and 50 bars.

The pressure may be applied during a time between 30 second and 20 minutes, preferably between 1 minute and 10 minutes.

The twisting leads to a homogeneous path length of all fibers in the thermoplastic composite. In addition, no buckling and crack occur. The twisting may be before the bending. The twisting may be according to a twist degree between 15° and 360° preferably at least 360°. For example, the fibers can be coupled to rotary motors which causes a twist in the fibers in a uniform and homogeneous manner.

The method according to the invention comprises a step of cooling 140 the bent section to solidify it and to form a bent thermoplastic composite.

Preferably the step of cooling is at a cooling temperature and/or a cooling duration. According to an embodiment, the cooling temperature and/or the cooling duration may be selected in accordance with the glass transition temperatures (Tg) of the bent thermoplastic composite. The Tg may be below 130° C., preferably below 120° C. and more preferably below 110° C. According to another embodiment, the cooling temperature and/or the cooling duration may be selected in accordance with the dimensions of the bent thermoplastic composite, according to the heating temperature, according to the heating duration, according to the type of heating, the number of bent and the type of bent, and/or the thermoplastic composite geometry.

According to another embodiment, the cooling temperature and/or the cooling duration may be in accordance with a cooling rate. For example, 0.1° C./s, 0.2° C./s, 0.3° C./s, 0.4° C./s, 0.5° C./s, 0.6° C./s, 0.7° C./s, 0.8° C./s, 0.9° C./s, preferably 0.2° C./s as a cooling rate for example for a D13 rod having a diameter of 13 mm.

For example, the cooling temperature may be less than or equal to 150° C., preferably less than or equal to 130° more preferably less than or equal to 110° and even more preferably less than or equal to 100° C. The cooling temperature may be more than or equal to 50° C., preferably more than or equal to 60° C., more preferably more than or equal to 70° C. even more preferably more than or equal to 80° C. The cooling temperature may be between 50° C. and 150° C., preferably between 60° C. and 130° C., more preferably between 70° C. and 130° C., even more preferably between 80° C. and 110° C.

Indeed, in order to bend the thermoplastic composite without reducing the mechanical and chemical properties, a temperature delta between the core temperature and the outside temperature can be controlled and/or monitored. If the core temperature is excessive, the outermost region and the surface of the thermoplastic composite are degraded. If the core temperature is not hot enough, bending cannot be carried out. In order to preserve the mechanical and chemical properties, the bending is preferably homogeneous.

Advantageous, the delta of the temperature between the inside and the outside temperature of the thermoplastic composite, preferably between the inside and the outside temperature of the bent portion of the thermoplastic composite, and between the heating step and the cooling step or during the step of creating a bend section is less than or equal to 50° C., preferably less than or equal to 40° C. more preferably less than or equal to 20° C. The delta of the temperature may be more than or equal to 0° C., preferably more than or equal to 5° C. more preferably more than or equal to 7° C. The delta of the temperature between the heating step and the cooling step may be between 0° C. and 50° C., preferably between 5° C. and 40° C. and more preferably between 7° C. and 20° C.

The delta of temperature is reached in less than or equal to 390 seconds, preferably in less than or equal to 120 seconds, more preferably in less than or equal to 60 seconds, even more preferably in less than or equal to 50 seconds. The delta of temperature may be reached in more than or equal to 5 seconds or less, preferably in more than or equal to 10 seconds, more preferably in more than or equal to 15 seconds, even more preferably in more than or equal to 20 seconds. Advantageously, the delta of temperature is reached between 10 and 390 seconds, preferably between 15 and 120 seconds and more preferably between 15 seconds and 60 seconds.

Preferably the temperature difference in the thermoplastic composite (inside the thermoplastic composite and outside temperature) after 60 seconds of heating preferably after 30 seconds of heating and after a cooling time at a temperature less than or equal to 150° C. is reached in less or equal to 390 seconds, preferably less than or equal to 200 seconds, more preferably less than or equal to 120 seconds, even more preferably in less than or equal to 90 seconds.

Preferably in order to bend a thermoplastic, the target core temperature may be between 110° C. and 210° C., preferably between 120° C. and 200° C., more preferably between 130° C. and 190° C. and even more preferably between 160° C. and 180° C.

Preferably, in order to not degraded the surface of the thermoplastic polymer, the target outside temperature may be between 200° C. and 250° C., preferably between 210° C. and 245° C., more preferably between 220° C. and 240° C. and even more preferably 220° C. and 230° C.

According to an embodiment illustrated in the FIGS. 2 and 3, the bending may be achieved when the curves of the outside temperature and the inside temperature intersect, i.e. at the intersection between the two curves there is a window where the delta of temperature is less than 50 degrees and preferences disclosed above. In fact, the outside temperature begins to decrease (cooling step) and the inside temperature stabilizes. Therefore, the low temperature delta is preferred. In addition, thanks to the invention (composition of the thermoplastic composite, geometry, and heating method), the temperature delta is quick to reach and therefore the method is faster. This avoids in particular the degradation of the mechanical and chemical properties but also the degradation on the surface, long manufacturing times and therefore reduce the cost of the manufacture.

The bending may depend on the geometry of the thermoplastic composite.

For example, for a thermoplastic composite rod between 5 mm and 30 mm of external diameter to bent, the target core temperature may be between 160° C. and 180° C., and between 30 second and 90 seconds, preferably in less than or equal to 60 seconds and/or more than 5 seconds.

For example, for a thermoplastic composite panel between 2 mm and 10 mm of thickness, the target core temperature may be between 160° C. and 180° C., and between 30 second and 90 seconds preferably in less than or equal to 30 seconds and/or more than 5 seconds.

Heating parameters to reach 160 to 240° C. in 30 s; Temperature difference in the thermoplastic composite after 30 s of heating, after cooling at Tₘᵢₙ>150° C. and cooling time before temperature reaches 150° C.

TABLE 5
Delta of temperature ΔT between heating and cooling
steps for different composites and heating means

| | Panel 2 mm | | Panel 4 mm | | Rod D13 | |
|---|---|---|---|---|---|---|
| | Heating | Cooling | Heating | Cooling | Heating | Cooling |
| Convective | B | <20 s | B | <50 s | C | |
| | | A | | A | | |
| Conductive | A | <30 s | A | <45 s | B | [20; 50 s] |
| | | B | | B | | A |
| Radial | A | <30 s | A | <60 s | B | [20; 50 s] |
| | | B | | B | | A |
| Volumetric | A | <30 s | A | <45 s | A | [20; 50 s] |
| | | B | | B | | A |

ΔT < 20° C.: A
20 < ΔT < 40° C.: B
ΔT > 40° C.: C

The heating duration of the convective heating is longer than conductive, radial and volumetric heating. In addition, the cooling time before the temperature reaches 150° C. is equivalent between convective, conductive, radial and volumetric. Moreover, the temperature delta during heating is very high with convective heating unlike conduction, radial or volumetric heating, and the delta of temperature during cooling is equivalent between conductive, radial or volumetric.

Examples of mechanical properties (in particular the degradation of the resin), bending, degradation for a bent thermoplastic composite with at least 65% of fibers in volume, with core temperature of the thermoplastic composite between 160° C. and 180° C. reaches in less than or equal to 90 seconds preferably less than or equal to 60 seconds, depending on the geometry of the thermoplastic composite.

TABLE 6
properties of different composites heated
by volumetric heating

| Volumetric | | | | |
|---|---|---|---|---|
| Heating | P2 | P4 | D13 | D16 |
| Bulking | 0 | 0.5 | 0 | 0.5 |
| Crack | 0 | 0 | 0 | 0 |
| Mechanical | 5 | 5 | 5 | 5 |
| Bending | 5 | 5 | 5 | 5 |
| Surface | 0 | 0 | 0 | 0 |
| degradation | | | | |

TABLE 7
properties of different composites heated
by radial heating

| Radial | | | | |
|---|---|---|---|---|
| Heating | P2 | P4 | D13 | D16 |
| Bulking | 0 | 0.5 | 0 | 0.5 |
| Crack | 0 | 0.5 | 0 | 0.5 |
| Mechanical | 5 | 5 | 5 | 5 |
| Bending | 5 | 5 | 5 | 5 |
| Surface | 0 | 0 | 0 | 0 |
| degradation | | | | |

TABLE 8
properties of different composites
heated by convective heating

| Convective | | | | |
|---|---|---|---|---|
| Heating | P2 | P4 | D13 | D16 |
| Bulking | 0.5 | 1 | 0.5 | 1 |
| Crack | 0.5 | 1.5 | 0.5 | 1.5 |
| Mechanical | na | na | na | na |
| Bending | 1 | 1 | 1 | 1 |
| Surface | na | na | na | na |
| degradation | | | | |

TABLE 9
properties of different composites heated by
conductive heating

| Conductive | | | | |
|---|---|---|---|---|
| Heating | P2 | P4 | D13 | D16 |
| Bulking | 0 | 0.5 | 0 | 0.5 |
| Crack | 0 | 0.5 | 0 | 0.5 |
| Mechanical | 5 | 4.5 | 5 | 4.5 |
| Bending | 5 | 4.5 | 5 | 4.5 |
| Surface | 0 | 0.5 | 0 | 0.5 |
| degradation | | | | |

In tables 6 to 9 the numbers signify: from 0 absent or insufficient, to 5 present or sufficient, .na: not applicable

The convection heating is much slower to reach inside and outsider target temperatures to be able to bend a thermoplastic composite. In addition, with the set time targets, a convection bending is not possible, the fibers crack and bulking phenomena appear.

Advantageously, the method according to the invention may comprise a step of welding, cutting, gluing or lamination.

According to another aspect, the invention comprises the manufacture of a thermoplastic composite. Preferably a thermoplastic composite according to the invention.

In one embodiment the thermoplastic composite is a (meth) acrylic thermoplastic composite. This means that the polymeric matrix of the thermoplastic composite comprises a (meth) acrylic polymer or consists of a (meth) acrylic polymer or of (meth) acrylic polymers.

The polymeric matrix may be made from a liquid composition a) or (meth) acrylic syrup comprising a (meth) acrylic polymer (PI), a (meth) acrylic monomer (M1).

The liquid (meth) acrylic syrup according to the invention comprises between 10 wt % and 50 wt % of a (meth) acrylic polymer (PI) and between 50 wt % and 90 wt % of a (meth) acrylic monomer (M1). Preferably the liquid (meth) acrylic syrup comprises between 10 wt % and 40 wt % of a (meth) acrylic polymer (PI) and between 60 wt % and 90 wt % of a (meth) acrylic monomer (M1); and more preferably between 10 wt % and 30 wt % of a (meth) acrylic polymer (PI) and between 70 wt % and 90 wt % of a (meth) acrylic monomer (M1).

The dynamic viscosity of the liquid composition a) or (meth) acrylic syrup is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the syrup can be easily measured with a Rheometer or viscosimeter. The dynamic viscosity is measured at 25° C. If the liquid (meth) acrylic syrup has a Newtonian behaviour, meaning no shear thinning, the dynamic viscosity is independent of the shearing in a rheometer or the speed of the mobile in a viscometer. If the liquid composition LC1 has a non-Newtonian behaviour, meaning shear thinning, the dynamic viscosity is measured at a shear rate of Is<−1>at 25° C.

As regards the liquid composition a) of the invention it comprises a (meth) acrylic monomer (M1) and a (meth) acrylic polymer (PI). Once polymerized the (meth) acrylic monomer (M1) is transformed to a (meth) acrylic polymer (P2) comprising the monomeric units of (meth) acrylic monomer (M1) and other possible monomers.

Preferably dynamic viscosity of the (meth) acrylic composition MCI is also in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s.

As regards the (meth) acrylic polymer (PI), mention may be made of polyalkyl methacrylates or polyalkyl acrylates. According to a preferred embodiment, the (meth) acrylic polymer (PI) is polymethyl methacrylate (PMMA).

According to one embodiment, the methyl methacrylate (MMA) homo- or copolymer comprises at least 70%, preferably at least 80%, advantageously at least 90% and more advantageously at least 95% by weight of methyl methacrylate.

According to another embodiment, the PMMA is a mixture of at least one homopolymer and at least one copolymer of MMA, or a mixture of at least two homopolymers or two copolymers of MMA with a different average molecular weight, or a mixture of at least two copolymers of MMA with a different monomer composition.

The copolymer of methyl methacrylate (MMA) comprises from 70% to 99.9% by weight of methyl methacrylate and from 0.1% to 30% by weight of at least one monomer containing at least one ethylenic unsaturation that can copolymerize with methyl methacrylate.

These monomers are well known, and mention may be made especially of acrylic and methacrylic acids and alkyl (meth) acrylates in which the alkyl group contains from 1 to 12 carbon atoms. As examples, mention may be made of methyl acrylate and ethyl, butyl or 2-ethylhexyl (meth) acrylate. Preferably, the comonomer is an alkyl acrylate in which the alkyl group contains from 1 to 4 carbon atoms.

According to a first preferred embodiment, the copolymer of methyl methacrylate (MMA) comprises from 80% to 99.9%, advantageously from 85% to 99.9% and more advantageously from 90% to 99.9% by weight of methyl methacrylate and from 0.1% to 20%, advantageously from 0.1% to 10% and more advantageously from 0.1% to 10% by weight of at least one monomer containing at least one ethylenic unsaturation that can copolymerize with methyl methacrylate. Preferably, the comonomer is chosen from methyl acrylate and ethyl acrylate, and mixtures thereof.

The weight-average molecular mass of the (meth) acrylic polymer (PI) should be high, which means greater than 50,000 g/mol and preferably greater than 100 000 g/mol.

The weight-average molecular mass can be measured by size exclusion chromatography (SEC).

The (meth) acrylic polymer (PI) is fully soluble in the (meth) acrylic monomer (M1) or in the mixture of (meth) acrylic monomers. It enables the viscosity of the (meth) acrylic monomer (M1) or the mixture of (meth) acrylic monomers to be increased. The solution obtained is a liquid composition generally called a “syrup” or “prepolymer”. The dynamic viscosity value of the liquid (meth) acrylic syrup is between 10 mPa·s and 10,000 mPa·s. The viscosity of the syrup can be readily measured with a rheometer or a viscometer. The dynamic viscosity is measured at 25° C.

Advantageously, the liquid (meth) acrylic composition or syrup contains no additional voluntarily added solvent.

As regards the (meth) acrylic monomer (M1), the monomer is chosen from alkyl acrylic monomers, alkyl methacrylic monomers, hydroxyalkyl acrylic monomers and hydroxyalkyl methacrylic monomers, and mixtures thereof.

Preferably, the (meth) acrylic monomer (M1) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

More preferably, the (meth) acrylic monomer (M1) is chosen from alkyl acrylic monomers or alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth) acrylic monomer (M1) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

More advantageously, the (meth) acrylic monomer (M1) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, and mixtures thereof.

According to a preferred embodiment, at least 50% by weight and preferably at least 60% by weight of the (meth) acrylic monomer (M1) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (M1) is a mixture of methyl methacrylate with optionally at least one other monomer.

As regards the (meth) acrylic monomer (M2), the monomer is multifunctional. Preferably the (meth) acrylic monomer (M2) is chosen from a compound comprising at least two (meth) acrylic functions. The (meth) acrylic monomer (M2) can also be chosen from a mixture of at least two compounds (M2a) and (M2b) each respectively comprising at least two (meth) acrylic functions.

The (meth) acrylic monomer (M2) can be chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris (2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy) ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate

Preferably the (meth) acrylic monomer (M2) is chosen from ethylene glycol dimethacrylate, neopentyl glycol diacrylate, neopentyl glycol dimethacrylate, 1,4-butanediol dimethacrylate, 1,4-butanediol diacrylate, 1,3-butylene glucol diacrylate, 1,3-butylene glycol dimethacrylate, triethylene glycol dimethacrylate and triethylene glycol diacrylate or mixtures thereof.

The (meth) acrylic monomer (M2) can be present in (meth) acrylic composition MCI between 0.01 and 10 phr by weight, preferably is present between 0.1 and 9.5 phr for 100 parts of a liquid (meth) acrylic syrup, more preferably between 0.1 and 9 phr, even more preferably between 0.1 and 8.5 phr and advantageously between 0.1 and 8 phr.

In a first more preferred embodiment the (meth) acrylic monomer (M2) is present in (meth) acrylic composition MCI between 0.01 and 9 phr and is chosen from a compound comprising two (meth) acrylic functions.

In a second more preferred embodiment the (meth) acrylic monomer (M2) is present in (meth) acrylic composition MCI between 0.01 and 9 phr and is chosen from a mixture of compounds comprising two (meth) acrylic functions.

In a third more preferred embodiment the (meth) acrylic monomer (M2) is present in (meth) acrylic composition MCI between 0.01 and 9 phr and is chosen from a mixture of compounds comprising at least two (meth) acrylic functions.

In a fourth more preferred embodiment the (meth) acrylic monomer (M2) is present in (meth) acrylic composition MCI between 0.01 and 9 phr and is chosen from a mixture of compounds comprising at least two (meth) acrylic functions. At least one compound of the mixture comprises only two (meth) acrylic functions and presents at least 50 wt % of the mixture of (meth) acrylic monomer (M2), preferably at least 60 wt %. The other compound of the mixture comprises more than two (meth) acrylic functions.

As regards the initiator (Ini) to start the polymerization of the (meth) acrylic monomers (M1) and (M2), it is chosen from a radical initiator.

Preferably the initiator (Ini) is activated by heat.

The radical initiators (Ini) can be chosen from a peroxy group comprising compound or an azo group comprising compounds and preferably from a peroxy group comprising compound.

Preferably the peroxy group comprising compound comprises from 2 to 30 carbon atoms.

Preferably the peroxy group comprising compound is chosen from diacyl peroxides, peroxy esters, peroxydicarbonates, dialkyl peroxides, peroxyacetals, hydroperoxide or peroxyketale.

The initiator (Ini) is chosen from diisobutyryl peroxide, cumyl peroxyneodecanoate, di (3-methoxybutyl) peroxydicarbonate, 1,1,3,3-Tetramethylbutyl peroxyneodecanoate, cumyl peroxyneoheptanoate, di-n-propyl peroxydicarbonate, tert-amyl peroxyneodecanoate,, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di (2-ethylhexanoylperoxy)-hexane, 1,1,3,3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1,1-di (tert-amylperoxy) cyclohexane, 1,1-di-(tert-butylperoxy)-cyclohexane, tert-amyl peroxy-2-ethylhexylcarbonate,, tert-amyl peroxyacetate, tert-butyl peroxy-3,5,5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4,4-di (tert-butylperoxy) valerate, tert-butyl peroxybenzoate, di-tert-amylperoxide, dicumyl peroxide, di-(2-tert-butyl-peroxyisopropyl)-benzene, 2,5-dimethyl-2,5-di-(tert-butylperoxy)-hexane, tert-butylcumyl peroxide, 2,5-dimethyl-2,5-di (tert-butylperoxy) hexyne-3, di-tert-butyl peroxide, 3,6,9-triethyl-3,6,9-trimethyl-1,4,7-triperoxonane, 2,2′-azobis-isobutyronitrile (AIBN), 2,2′-azodi-(2-methylbutyronitrile), azobisisobutyramide, 2,2′-azobis (2,4-dimethylvaleronitrile), 1,1′-Azodi (hexahydrobenzonitrile), or 4,4′-azobis (4-cyanopentanoic).

Preferably the initiator (Ini) is chosen from cumyl peroxyneodecanoate, di (3-methoxybutyl) peroxydicarbonate, 1,1,3,3-tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di (2-ethylhexanoylperoxy)-hexane or 1,1,3,3-tetramethylbutyl peroxy-2-ethylhexanoate.

As regards the fibrous substrate, mention may be made of several fibers, unidirectional rovings or continuous filament mat, fabrics, felts or nonwovens that may be in the form of strips, laps, braids, locks or pieces. The fibrous material may have various forms and dimensions, either one-dimensional, two-dimensional or three-dimensional. A fibrous substrate comprises an assembly of one or more fibers. When the fibers are continuous, their assembly forms fabrics.

The one-dimensional form corresponds to linear long fibers. The fibers may be discontinuous or continuous. The fibers may be arranged randomly or parallel to each other, in the form of a continuous filament. A fiber is defined by its aspect ratio, which is the ratio between the length and diameter of the fiber. The fibers used in the present invention are long fibers or continuous fibers. The fibers have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10,000.

The two-dimensional form corresponds to nonwoven or woven fibrous mats or reinforcements or bundles of fibers, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibers or mixtures thereof, an assembly of the two-dimensional form in the third dimension.

The origins of the fibrous material may be natural or synthetic. As natural material one can mention plant fibers, wood fibers, animal fibers or mineral fibers.

Natural fibers are, for example, sisal, jute, hemp, flax, cotton, coconut fibers, and banana fibers. Animal fibers are, for example, wool or hair.

As synthetic material, mention may be made of polymeric fibers chosen from fibers of thermosetting polymers, of thermoplastic polymers or mixtures thereof.

The polymeric fibers may consist of polyamide (aliphatic or aromatic), polyester, polyvinyl alcohol, polyolefins, polyurethanes, polyvinyl chloride, polyethylene, unsaturated polyesters, epoxy resins and vinyl esters.

The mineral fibers may also be chosen from glass fibers, especially of E, R or S2 type, carbon fibers, boron fibers or silica fibers.

The fibrous substrate of the present invention is chosen from plant fibers, wood fibers, animal fibers, mineral fibers, synthetic polymeric fibers, glass fibers and carbon fibers, and mixtures thereof.

Preferably, the fibrous substrate is chosen from mineral fibers. More preferably the fibrous substrate is chosen from glass fibers or carbon fibers.

The fibers of the fibrous substrate have a diameter between 0.005 μm and 100 μm, preferably between 1 μm and 50 μm, more preferably between 5 μm and 30 μm and advantageously between 10 μm and 25 μm.

Preferably, the fibers of the fibrous substrate of the present invention are chosen from continuous fibers (meaning that the aspect ratio does not necessarily apply as for long fibers) for the one-dimensional form, or for long or continuous fibers for the two-dimensional or three-dimensional form of the fibrous substrate.

The present invention relates additionally to a method for preparing a polymeric composite PCI from a (meth) acrylic composition MCI, said method comprises the following steps:
i) impregnating fibers or a fibrous substrate with the (meth) acrylic composition MCI comprising:
   a) 100 parts of a liquid (meth) acrylic syrup comprising
   a1) between 10 wt % and 50 wt % of a (meth) acrylic polymer (PI),
   a2) between 50 wt % and 90 wt % of a (meth) acrylic monomer (M1) comprising only one (meth) acrylic function, and
   b) between 0.01 and 10 phr by weight of a (meth) acrylic monomer (M2) comprising at least two (meth) acrylic functions;
   c) between 0.1 phr and 5 phr of a initiator (Ini) to start the polymerization of the (meth) acrylic monomer (M1) and (meth) acrylic comonomer (M2);
ii) polymerizing the (meth) acrylic composition MCI, that has impregnated the fibers or fibrous substrate.

The components a) to c) in the method for preparing a polymeric composite are the same as defined before and their respective weight ratios.

The polymerization step takes place at a temperature typically below 140° C., preferably below 130° C. and even more preferably below 125° C.

Preferably the polymerization step takes place at temperature between 40° C. and 140° C., preferably between 50° C. and 130° C., even more preferably between 60° C. and 125° C.

The polymeric composite PCI is preferably a (meth) acrylic polymeric composite.

The polymeric composite PCI is preferably fiber reinforced polymeric composite.

According to another aspect, the invention concerns a bent thermoplastic composite.

A bent thermoplastic composite is preferably obtained from a thermoplastic composite comprising 35% or less in volume of a polymeric matrix including (meth)acrylic polymers, and at least 65% in volume of fiber. It may be also obtained from a thermoplastic composite comprising from 20% to 30% in volume of a polymeric matrix including (meth)acrylic polymers, and from 70% to 80% in volume of fiber.

Preferably the bent thermoplastic composite is obtainable from the method according to the invention, more preferably it is obtained from the method according to the invention.

A bent thermoplastic composite may comprise several shapes. A bent may be a curvature, a twisting, a folding, a compression. Preferably the bent is a twisting. According to a preferred embodiment, the thermoplastic composite comprises a change of its form in at least one portion of the whole thermoplastic composite.

A bent thermoplastic composite is preferably a reinforcing element to reinforcing a structure. A reinforcing element may be for example a panel, a rod, a bar, a rebar, sheet. According to an embodiment, the thermoplastic composite may comprise several sheets. Preferably, the thermoplastic composite is a rebar.

A bent thermoplastic composite may have different geometries such as conical, pyramidal, oval, flat, linear, circular.

The thermoplastic composite may have different dimension (thickness, diameter, length, width, height).

The thermoplastic composite may have a thickness of at least 2 mm preferably at least 3 mm, more preferably at least 4 mm and even more preferably at least 5 mm. Preferably the thermoplastic composite may have a thickness less than or equal to 35 mm, preferably less than or equal to 30 mm, more preferably less than or equal to 25 mm. Preferably, the thermoplastic composite may have a thickness between 2 mm and 35 mm, preferably between 3 mm and 30 mm, more preferably between 4 mm and 25 mm.

The thermoplastic composite may have an external diameter of at least 5 mm preferably at least 6 mm, more preferably at least 10 mm and even more preferably at least 13 mm. The thermoplastic composite may have an external diameter less than or equal to 40 mm, preferably less than or equal to 35 mm, more preferably less than or equal to 30 mm and even more preferably less than or equal to 25 mm. The thermoplastic composite may have an external diameter between 5 mm and 40 mm, preferably between 6 mm and 35 mm, more preferably between 10 mm and 30 mm and even more preferably between 13 mm and 25 mm.

Preferably, the thermoplastic composite is not limited by length.

Advantageously, the bent thermoplastic composite according to the invention meets all the requirements of the Standard Test Method for Strength of Fiber Reinforced Polymer (FRP) Bent Bars in Bend Locations (ASTM D7914).

Advantageously, the bent thermoplastic composite according to the invention meets all the requirements of the standard Specification for Solid Round Glass Fiber Reinforced Polymer Bars for Concrete Reinforcement (ASTM7957).

Advantageously, the bent thermoplastic composite according to the invention meets all the requirements of the Standard Test Method for Measuring the Curved Beam Strength of a Fiber-Reinforced Polymer-Matrix Composite (ASTM D6415).

A bent thermoplastic composite according to the invention is particularly suitable for reinforcing a structure.

According to another aspect, the invention concerns a use of a bent thermoplastic composite according to the invention in automotive, transport, nautical, railroad, sport, aeronautic, aerospace, photovoltaic, construction and building, and/or wind energy applications

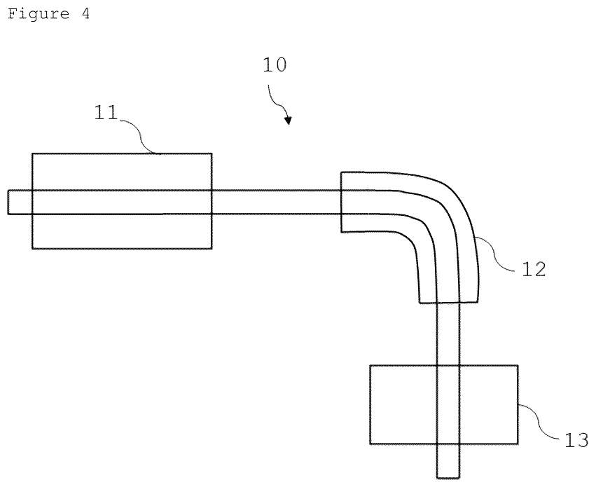

According to another aspect of the invention, it concerns a system 10 for manufacturing a bent thermoplastic composite from thermoplastic composite, preferably according to the invention. Said thermoplastic composite comprises 35% or less in volume of a polymeric matrix including (meth)acrylic polymers, and at least 65% in volume of fiber. An example of the system is illustrated in the FIG. 4.

Advantageously, the system is suitable for implementing the method according to the invention.

A system according to the invention comprises a heating device, a bending device, and a cooling device.

A heating device 11 may be configured to heat a portion of the thermoplastic composite. The heating device allows to locally heat a portion, or several portions, of the thermoplastic composite and to soften it for the final bending. Advantageously, the heating device may be configured to heat the portion directly or indirectly, i.e. by direct contact or not, for example by heat transfer. Per portion should be understood one or more portions of the thermoplastic composite and of one or more surfaces of the portion of the thermoplastic composite.

The heating device may be selected between, conduction, radial and/or volumetric.

The heating device may comprise a mold, an enclosure, a microwave source, an IR source (NIR/MIR), an air blower and/or an induction source. Preferably the heating device comprises an infrared heating device or a microwave heating device. This ensures a sufficiently uniform heating of the portion to be heated to the core of the thermoplastic composite in relatively short times, without the temperature in the surface of the thermoplastic composite rising so much that the thermoplastic material changes into the fluid state or exhibits surface degradation or changes in its properties.

Advantageously the heating device may be programmable in order to determine a heating temperature, a temperature to be reached (core and/or surface) and/or a heating time.

Advantageously, the heating device may comprise one or more IR or thermometer type heating sensors in order to control the different heating temperatures and/or a timer, to control the heating time.

Advantageously, the device may also include an alarm configured to alert when the temperature or duration has been exceeded or to alert when the temperature or the duration is reached.

Preferably, the heating device is arranged upstream of the bending device.

According to one embodiment, the heating device may be digitally/automatically controlled and/or moved or manually controlled and/or moved to a heating position and removed. Advantageously, the heating device may be removable.

The system according to the invention may comprise a bending device 12. A bending device is configured to create a bent section in the heated portion by bending the heated portion.

A bending device may comprise twisting, bending, curving and/or folding means.

For example, the bending device may comprise a bending area with a bending arm which may rotate around the bending area and which has a clamp for clamping the heated portion. The bending arm and the bending area may each rotate about a predetermined bending axis.

A bending device may include clamps, clamping jaws for clamping the heated portion and bending it.

A bending device may be movable.

Alternatively, the heated portion may be rotatable, for example using rollers, reels, motorized or not. The angle of rotation may be predetermined as well as the speed of rotation. Depending on the magnitude of the torsion, provision may be made for the bending device to perform a controlled compensatory movement in the longitudinal direction of the heated portion.

According to another embodiment, the bending device may for example comprise one or more folding rollers or opposing belts or opposing folding surfaces or opposing belts, or opposing folding surfaces, which bend the locally heated portion so as to accomplish said final bending.

The system according to the invention may comprise a cooling device 13.

A cooling device is configured to solidify the bent section and to form a bent thermoplastic composite.

Preferably, the cooling device allows to cool the heated portion sufficiently so that the said heated portion becomes solid again and may be removed from the bend form without deformation.

Advantageously, the cooling device may be configured to cool the bent portion directly or indirectly, i.e. by direct contact or not. Per bent portion should be understood one or more bent portions of the thermoplastic composite and of one or more surfaces of the bent portion of the thermoplastic composite.

A cooling device may comprise a cooling of the bent portion to a cooling temperature at which the bent section changes to a thermoplastic or solid state. Preferably the cooling temperature is below the glass transition temperature of the thermoplastic composite, for example less than or equal to 120° C., preferably less than or equal to 110° C.

In addition, a cooling device is provided in order to achieve rapid cooling of the bent section. Preferably less than or equal to 390 seconds.

Advantageously, it may be instantaneous or alternatively a slow cooling.

For this purpose, the bending device may be equipped with a cooling device to actively cool the bent portion. This may include compressed air.

Alternatively, the cooling device may include passive cooling or automatic cooling. It may be a mold, a nozzle, a refrigerant circuit, a flow of a cooling fluid and/or fan.

According to one embodiment, the cooling device may be integrated directly into the bending device.

The system may be arranged along a pultrusion device. A pultrusion device comprises all the device mandatory to the pultrusion such as feeding device, resin bath, impregnation device, pulling device, evacuation device.

Advantageously, the system may comprise an IHM or an automatization module to configure parameters of the system and monitored, controlled, and manage all the devices of the system, such as temperature and/or duration.

The invention can be the subject of numerous variants and applications other than those described above. Unless otherwise indicated, the different structural and functional characteristics of each of the implementations described above should not be considered as combined and/or closely and/or inextricably linked to each other, but on the contrary as simple juxtapositions. In addition, the structural and/or functional characteristics of the different embodiments described above may be the subject in whole or in part of any different juxtaposition or any different combination.

1. Method for producing a bent thermoplastic composite, from thermoplastic composite, said thermoplastic composite comprising 35% or less in volume of a polymeric matrix including (meth)acrylic polymers, and at least 65% in volume of fiber, said method comprising:
a step of providing the thermoplastic composite, preferably from a pultrusion process,
a step of heating a portion of the thermoplastic composite, said heating being selected between, conduction, radial and/or volumetric and a heating duration and/or a heating temperature being selected according to at least a thickness of the thermoplastic composite,
a step of creating a bent section in the heated portion by bending the heated portion, and
a step of cooling the bent section to solidify it and to form a bent thermoplastic composite, at a cooling temperature and/or a cooling duration selected in accordance with the glass transition temperature (Tg) of the bent thermoplastic composite.

2. Method according to claim 1, wherein the step of heating is a radial heating, preferably an IR heating.

3. Method according to claim 1, wherein the heating duration is less than or equal to 95 seconds, preferably less than or equal to 60 seconds, preferably with an inside temperature of the thermoplastic composite being less than or equal to 180° C.

4. Method according to claim 1, wherein between the step of heating and the step of cooling, the difference of temperature between an inside temperature and an outside temperature of thermoplastic composite goes from 0° C. to 50° C.

5. Method according to claim 1, wherein the temperature difference between an inside temperature and an outside temperature of thermoplastic composite during the heating step is less than or equal to 80° C., preferably in less than or equal to 95 seconds of heating.

6. Method according to claim 1, wherein the thermoplastic composite is obtained from a pultrusion process, preferably a reactive pultrusion process.

7. Method according to claim 1, wherein said thermoplastic composite is crosslinked or partially crosslinked or not.

8. Method according to claim 1, wherein the outside temperature in the heated portion of thermoplastic composite is between 140° C. and 230° C., the heating duration is less than or equal to 95 seconds.

9. Method according to claim 1, wherein the outside temperature in the heated portion of thermoplastic composite is from 200° C. to 250° C., the heating duration is less than or equal to 95 seconds.

10. Method according to claim 1, wherein the step of creating the bent is made by simple bending, compression curving, folding and/or twisting.

11. Method according to claim 1, wherein the thermoplastic composite is a (meth)acrylic thermoplastic composite.

12. A bent thermoplastic composite obtained from a thermoplastic composite said thermoplastic composite including 35% or less in volume of a polymeric matrix including (meth)acrylic polymers, and at least 65% in volume of fiber.

13. Use of a bent thermoplastic composite according to claim 12 in automotive, transport, nautical, railroad, sport, aeronautic, aerospace, photovoltaic, construction and building, and/or wind energy applications.

14. A system for manufacturing a bent thermoplastic composite from thermoplastic composite, said thermoplastic composite comprising 35% or less in volume of a polymeric matrix including (meth)acrylic polymers, and at least 65% in volume of fiber, said system comprising:
a heating device which is configured to heat a portion of the thermoplastic composite, said heating device being selected between, conduction, radial and/or volumetric and the heating duration and/or the heating temperature being selected according to at least the thickness of the thermoplastic composite,
a bending device which is configured to create a bent section in the heated portion by bending the heated portion, and
a cooling device which is configured to solidify the bent section and to form a bent thermoplastic composite, at a cooling temperature and/or a cooling duration selected in accordance with the glass transition temperature of the thermoplastic composite.

15. The system according to claim 14, wherein the heating device comprises a mold, an enclosure, a microwave source, an IR source (NIR/MIR), an air blower and/or an induction source.

16. The system according to claim 14, wherein the heating device comprises an infrared heating device or a microwave heating device.

17. The system according to claim 14, wherein the system is arranged along a pultrusion device.
